(19) United States
(12) Patent Application Publication
(10) Pub. No.: US 2026/0124545 A1
(43) Pub. Date: May 7, 2026

(54) SYSTEMS AND METHODS FOR UTILIZING AN AI FRAMEWORK TO DESIGN TIME-AWARE GAMES

(71) Applicant: Adeia Guides Inc., San Jose, CA (US)

(72) Inventors: Zhiyun Li, Kenmore, WA (US); Ning Xu, Irvine, CA (US)

(21) Appl. No.: 18/935,083

(22) Filed: Nov. 1, 2024

(51) Int. Cl. A63F 13/67; G06N 3/084

(52) U.S. Cl. CPC A63F 13/67; G06N 3/084

(57) ABSTRACT

Systems and methods are described for using a deep learning model to conform a computing session for an electronic game to a time window. The disclosed methods may determine a time window for completing the computing session. The determined time window is input into the deep learning model, which includes a policy network trained to suggest in-game actions, a value network trained to determine a particular outcome from a specific game state and an upper confidence bound (UCB) for guiding a search algorithm of a data structure. Based on an output of the deep learning model, the disclosed methods may determine an in-game action to perform that will advance the electronic game towards a desired outcome of the computing session, within the time window. Thus, computing sessions may be configured to fit into a user's busy schedule, and critical computing resources may be conserved.

### FIELD OF DISCLOSURE

The present disclosure relates to applying machine learning (ML) or artificial intelligence (AI) to manage game play. The present disclosure further relates to adapting and applying an AI or ML model to conform a computing session of an electronic game to conclude or otherwise reach a particular game state within a specified time frame or window.

### SUMMARY

Artificial intelligence and/or machine learning models are often used as opponents in gaming sessions. Typically, such AI models can be trained to outmatch players easily. AI models, especially in turn-based electronic games, can analyze thousands of in-game moves (or more) in real-time, as well as probable consequences of those moves, and choose the best strategy for any given instant. Similarly, AI-based opponent models can be trained to play at certain levels of competition (e.g., difficulties) such as novice/easy, intermediate/medium, experienced/hard, and beyond/master. In some cases, games may offer AI-based training for players, which gradually elevates the difficulty to encourage player development and replay. However, dynamically changing the difficulty of a gaming session can squander valuable resources that may be otherwise conserved if the AI model did not change. For example, an AI gaming model-even models initially set to “novice”-requires computing resources such as processors, memory, input/output connections, and more. Using resources for two or more AI-based opponent models, operating at different difficulty levels (e.g., novice and experienced), during one gaming session is inefficient. Computing resources, e.g., local resources and/or shared cloud resources, can be better optimized by scheduling an electronic gaming session with an AI-opponent to fit within a particular time window. Moreover, an AI-based opponent behaving inconsistently throughout the electronic gaming session time window may undermine the game experience. There exists a need to manage computing resources using a specified time window for a gaming session.

In some approaches, game developers have created an AI-based opponent that is conditioned to attempt to win the game as quickly as possible. In some approaches, game developers have created an AI-based opponent that is conditioned to take additional time to make in-game moves. In some approaches, game developers have created an AI-based opponent that might behave erratically and jump to different difficulty levels at different times, e.g., playing as an expert one second and then as a novice the next turn.

Some approaches to manage video game time include managing the “units of content” that may be present in a video game. The system selects certain units of content according to a user's available playing time. For instance, a game system may present a particular quest or challenge that is expected to fit into an allotted amount of time. However, this approach lacks the flexibility and granularity required for providing impromptu gaming sessions, since the units of content have to be defined and configured in the initial game design stage. Additionally, it is questionable to skip some units of content without compromising the integrity of the game, unless those units of content are some kind of introductory cutscenes/tutorial in the game, which can typically be skipped manually. Furthermore, this technique may not apply to a wider range of games, such as turn-based games, which do not typically have the flexibility to rearrange the actions or only select certain actions.

Other approaches may dynamically adjust the game's difficulty level. The goal of this approach is to design a game with a difficulty level that is most likely to keep a user engaged for a longer period of time. For example, some players with a higher skill set prefer to play the game at a more challenging difficulty, while more beginner players may prefer to play the game at an easier difficulty. Although a game's difficulty level may be associated with a duration of a gaming session, it does not control the duration of the gaming session directly. For example, if the difficulty level is too low or too high for the user, in either case the game may end early.

One of the major issues that arise in this regard is the unpredictability in allocating resources to AI-based opponents. For example, a game of chess can last anywhere from a few minutes to several hours, making it difficult for the game system to gauge how many resources to dedicate to a particular computing session. Additionally, it is often desirable to play a game against an AI-based opponent at higher difficulty levels, but without the game system allocating too many resources to the AI model, so that the game system may utilize the excess resources for other game functions. Switching between different AI models or game difficulty levels may require a game system to expend more resources than are necessary to restrain a computing session to a particular time period.

To help address the limitations and problems of the above approaches, systems and methods are disclosed herein for efficiently conforming a computing session for an electronic game into a time window using a deep learning model. For example, the game system initiates a computing session to play a game, which may be any kind of electronic game. Subsequent to receiving the first user-interface input, the game system determines a time window or maximum gameplay duration for completing the computing session, which may be manually selected or provided by the user. In some embodiments, the game system is programmed to determine the user's preferred time window by accessing the user's calendar to determine availability, or by analyzing patterns in the user's historical gameplay data (e.g., the user commonly plays for about 30 minutes between 5-6 pm). The game system then inputs or applies the time window to the deep learning model to accurately conform a computing session for a game to the user's available time window.

According to an embodiment, the game system trains a time-aware policy network of the deep learning model based on a plurality of game states of the game, a number of remaining steps to complete the computing session from a particular game state and the time window, where each step of the number of remaining steps is associated with an amount of time. The time-aware policy network is applied to a computing session to determine possible in-game moves for advancing the computing session to a particular outcome, based on a current game state. The game system also trains a time-aware value network of the deep learning model based on various game states of previous computing sessions and the average number of remaining steps to complete each previous computing session. The game system also trains the deep learning model by calculating an upper confidence bound (UCB) value based on the time window and a reward value for searching each node in a data structure using a search algorithm. In an embodiment, the search algorithm is a heuristic search algorithm, such as a Monte Carlo Tree Search (MCTS). In some embodiments, each node in the date structure represents an in-game move that is determined to advance the session to a particular outcome.

Once the deep learning model is trained based on historic gaming data and a current state of the computing session as it relates to the timing window, the game system determines an action for the deep learning model to perform to advance the computing session to a particular outcome within the time window. For example, the action may be a move made by a computer-controlled player in the game (e.g., moving a chess piece). In another example, the action may be providing the player with a hint or suggested move to help advance the computing session to the particular outcome within the time window. The above process may be performed in response to each decision a human and/or computer player makes during a computing session for an electronic game, ensuring precise control over playtime regardless of difficulty level. In some embodiments, the in-game action is different depending on type or category of game being played.

Such aspects of the present disclosure leverage the efficient searching capabilities of the AI framework to make a wide range of games fit into the user's time constraints while keeping the experience consistent and productive. In addition, by utilizing a deep learning model that analyzes a data structure of connected nodes to determine the best in-game move for maintaining the gameplay window of the computing session, the deep learning model does not need to search each possible move, of a number of potentially infinite moves, for completing the computing session within the time period. By searching only the possible decisions stemming from one node in the data structure, the gaming system saves processing power and conserves valuable resources. This allows a game system to present a computing session at a higher difficulty level, while conserving critical resources and without compromising user enjoyment.

In some embodiments, a time-aware policy network suggests possible in-game moves for completing the computing session within the time period. In some embodiments, the time-aware policy network is trained on a large data set of expert gaming sessions, to learn and predict the in-game moves a human expert would make. In some embodiments, the time-aware policy network is trained by playing numerous games against itself, using the outcomes to update its parameters. In some embodiments, the time-aware policy network includes a loss function involving cross-entropy loss between the predicted in-game move probabilities and the target in-game move probabilities. For example, the loss represents any difference between the impact of a predicted move and the actual impact that the predicted move has on the computing session, once it is implemented into the computing session.

In some embodiments, a time-aware value network evaluates game states and an estimated average number of remaining steps to predict an outcome of the computing session (e.g., a winner, a loser, not losing, solving a given puzzle, completing a particular quest, advancing the game state, or any other suitable outcome desired by the user). In some embodiments, the time-aware value network is trained to predict the probability of winning from a given game state. In some embodiments, the time-aware value network is trained using self-play games, with training data including each game state labeled by the eventual game outcome (e.g., a win or a loss). In some embodiments, the time-aware value network includes a combined loss function that integrates binary cross-entropy (BCE) loss for the win probability and mean squared error (MSE) loss for the steps remaining.

In some embodiments, the time-aware UCB calculation is directly associated with the selection phase of the MCTS, which is used to search the nodes of the data structure. For example, the time-aware UCB calculation balances exploration (e.g., selecting less-visited nodes to discover their potential) and exploitation (e.g., selecting nodes that have yielded high rewards in the past). Thus, in some embodiments, the MCTS prioritizes certain suggested actions or decisions over others indicated in the data structure. In some embodiments, the time-aware UCB calculation is constrained by the time window for completing the computing session. For example, the time-aware UCB calculation may consider upper and lower bound penalties assigned to moves that are expected to extend the game's duration beyond the target time window or moves that are expected to end the game too soon, respectively. In some embodiments, the time-aware UCB calculation indicates a level of urgency to complete the computing session within the target time window, which allows the deep learning model to adapt its strategy based on the remaining time.

In some embodiments, the deep learning model is adapted to consider the human player's chosen difficulty level, such that the entire computing session of a game will remain at the chosen difficulty level until the conclusion of the computing session, resulting in a consistent gaming experience. In some embodiments, a game is played at a certain difficulty level to allow the AI opponent to have enough flexibility to effectively manage the applicable time constraints. In some embodiments, the difficulty level is initially selected by the user. In some embodiments, a computing device estimates the difficulty level based on analyzing the user's gameplay history or analyzing crowd-sourced statistics obtained from many other users.

In some embodiments, the deep learning model causes the gaming system to perform an action in order to complete the computing session of the game within the time period. In some embodiments, the action is providing the user with hints to complete a challenge or overcome some obstacle. In some embodiments, the action relates to providing suggested moves for an AI opponent. For example, an AI opponent may be provided with a suggestion, by the game system, to make certain in-game moves, which provide the human player with an advantage and ability to win the game against the AI opponent within the time period. In some embodiments, the action is any other suitable action for interacting with a portion of content of the electronic game to conclude or advance the computing session to a particular outcome within the time period.

In some embodiments, the above techniques are utilized for an AI deep learning model to complete a computing session for many different types of electronic games. For example, the AI deep learning model may be adapted and applied to turn-based strategy games (e.g., chess, shogi and checkers), real-time strategy games (e.g., StarCraft and Age of Empires), role-playing games (e.g., Final Fantasy Tactics and For The King), puzzle games (e.g., sudoku and Tetris), board games (e.g., Risk and Settlers of Catan), or any other suitable electronic game.

In some embodiments, the game system generates a user interface display to indicate the actions performed by the deep learning model. In some embodiments, depending on the type of game that the deep learning model is applied to, the generated user interface displays hints provided by the deep learning model for completing the computing session of the game within the time frame. In some embodiments, depending on the type of game that the deep learning model is applied to, the generated user interface displays an indication of any suitable action performed by the deep learning model for completing the computing session of the game within the time frame. For example, if the applicable game is a role-playing game, the generated user interface may display recommendations from the deep learning model to help complete a series of quests within the time frame or a suggestion of optimal movement, skills and abilities for defeating an important enemy within the time frame.

### BRIEF DESCRIPTION OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

The embodiments herein may be better understood by referring to the following description in conjunction with the accompanying drawings, in which like reference numerals indicate identical or functionally similar elements, of which:

FIG. 1A depicts an illustrative system for conforming a computing session for an electronic game into a time window using a deep learning model, in accordance with some embodiments of the disclosure;

FIG. 1B depicts an exemplary system for sharing resources of an electronic game using a computer-based opponent, in accordance with some embodiments of the disclosure;

FIG. 2 depicts a flow diagram of an example process for conforming a computing session for an electronic game into a time window using a deep learning model, in accordance with some embodiments of the disclosure;

FIG. 3 depicts an example diagram of training a learning model using supervised learning, in accordance with some embodiments of the disclosure;

FIG. 4A depicts an illustrative system for using a Monte Carlo Tree Search (MCTS), in a learning model, to search through nodes of a data structure, in accordance with some embodiments of the disclosure;

FIG. 4B depicts an example diagram of how an upper confidence bound (UCB) is applied to the MCTS, in accordance with some embodiments of the disclosure;

FIG. 5 depicts an example diagram of a time-aware policy network in a learning model, in accordance with some embodiments of the disclosure;

FIG. 6 depicts an example diagram of a time-aware value network in a learning model, in accordance with some embodiments of the disclosure;

FIG. 7 depicts illustrative devices and systems for conforming a computing session for an electronic game into a time window using a deep learn model, in accordance with some embodiments of the disclosure;

FIG. 8 depicts devices and systems including a server, a communication network, and computing devices for performing the methods and processes noted herein, in accordance with some embodiments of the disclosure;

FIG. 9 is a flowchart of the process for performing an action to conform a computing session for an electronic game into a time window using a deep learn model, in accordance with some embodiments of the disclosure;

FIG. 10 is a flowchart of the process for performing a MCTS, in accordance with some embodiments of the disclosure;

FIG. 11 is a flowchart of the process for calculating the UCB and applying the UCB to the MCTS, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices and methods specifically described herein and illustrated in the accompanying drawings are non-limiting embodiments and that the scope of the present invention is defined solely by the claims.

### DETAILED DESCRIPTION

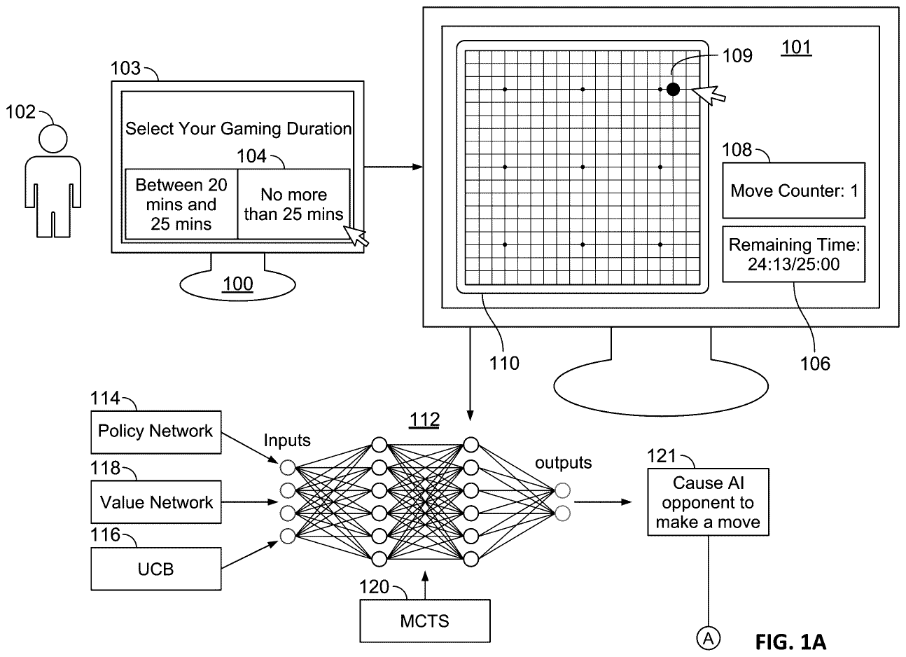

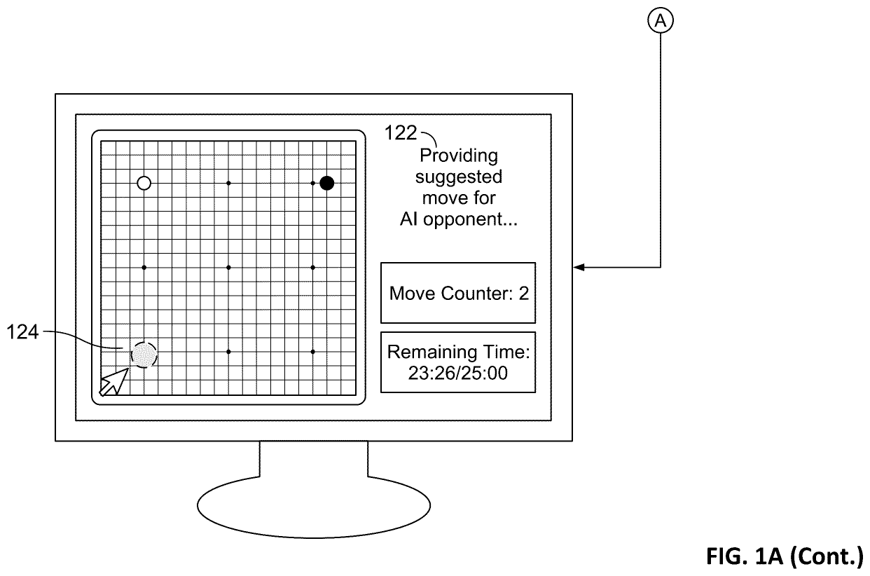

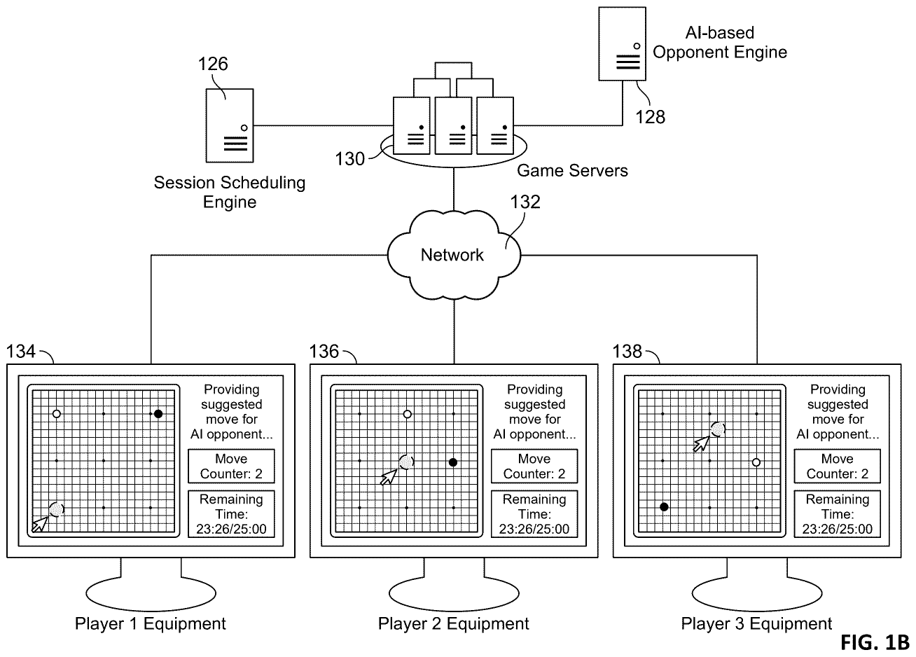

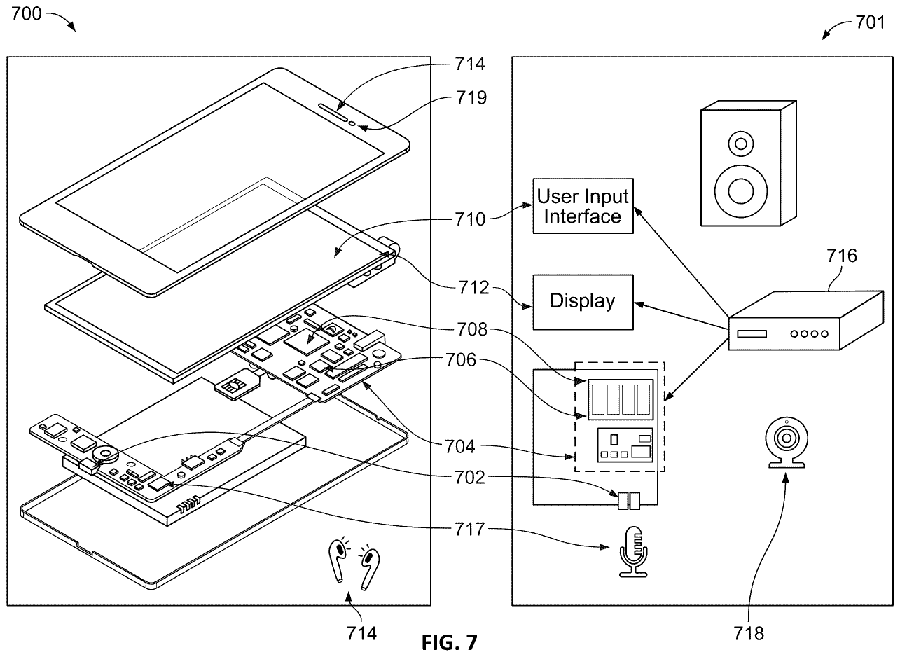

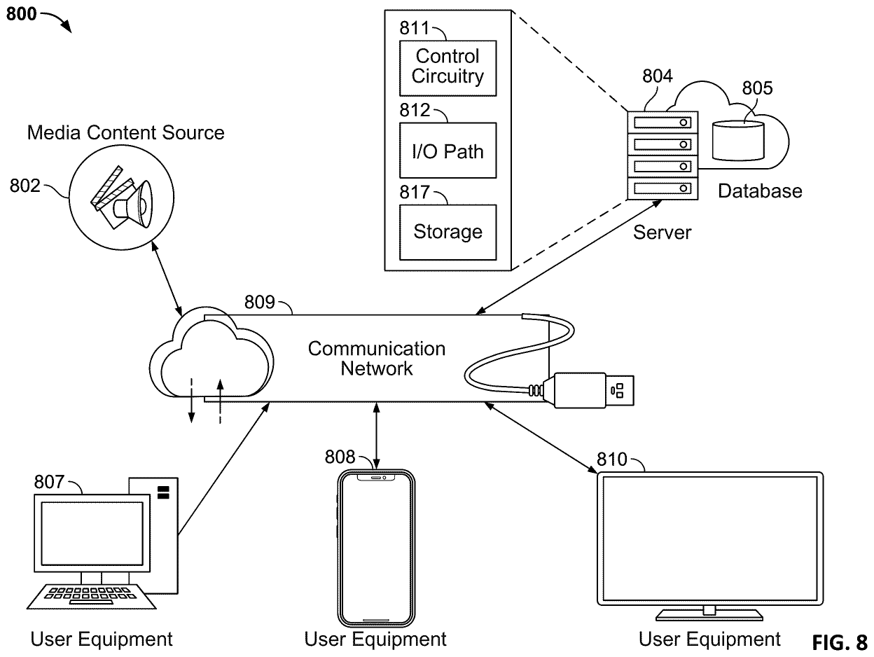

FIG. 1A depicts an illustrative game system 100 for conforming a computing session for an electronic game into a time window using a deep learning model, in accordance with some embodiments of the disclosure. The techniques described herein may be implemented, at least in part, using a game system that may correspond to or comprise game system 100 of FIG. 1A. The game system may correspond to or comprise a game application that provides an electronic game to game system 100, which may be executed at least in part on computing device 103 and/or at one or more remote servers (e.g., server 804 of FIG. 8 and/or media content source 802 of FIG. 8), and which may utilize storage devices (e.g., database 805 of FIG. 8), at or distributed across any of one or more other suitable computing devices, in communication over any number and/or types of networks (e.g., the internet). The game application may be configured to perform the functionalities (or any suitable portion of the functionalities) described herein. In some embodiments, the application and/or system may comprise or employ any suitable number of displays, sensors or devices, such as those further described in relation to FIGS. 7 and 8 or any other suitable software and/or hardware components, or any combination thereof. In some embodiments, the control circuitry of computing device 103 is control circuitry 704 or 811, as further described in relation to FIGS. 7 and 8 below. In some embodiments, the computing device, at which the game application may be executed at least in part, is user equipment 807, 808 and 810 of FIG. 8. In some embodiments, the control circuitry executes the functions of the game application based on instructions stored in non-transitory memory (e.g., non-transitory memory or storage 708 of FIG. 7, and storage 817 of server 804 in FIG. 8), which may be provided by learning model 112 of FIG. 1A. By executing the instructions, input/output (I/O) circuitry and/or the control circuitry translates user inputs, received at the computing device, into in-game actions.

In some embodiments, the game application may be installed at or otherwise provided to a particular computing device and may be provided via an application programming interface (API) or may be provided as an add-on application to another platform or application. In some embodiments, software tools (e.g., one or more software development kits, or SDKs) may be provided to any suitable party, to enable the party to implement the functionalities described herein.

Electronic game 101 may be any type of electronic game, e.g., a turn-based strategy game (e.g., chess or checkers), a real-time strategy (RTS) game (e.g., StarCraft or Age of Empires), a role-playing game (RPG) (e.g., Tactical RPGs like Final Fantasy Tactics or Baldur's Gate), a puzzle game (e.g., sudoku or Tetris), a board game (e.g., Risk or Settlers of Catan), or any other suitable game that comprises a physical manifestation of computer-based actions, provided via any suitable device 103 or platform (e.g., via a game console, smartphone application, tablet, desktop, internet, or any other suitable platform, or any suitable combination thereof). In some embodiments, electronic game 101 is either a single player or a multi-player game. In the example of FIG. 1A, electronic game 101 may be an electronic board game, including move counter 108, clock 106, game board 110 and initial move 109. Computing device 103 may be, for example, a mobile device such as, for example, a smartphone or tablet. In some embodiments, computing device 103 comprises or corresponds to a gaming console, a laptop computer, a personal computer, a desktop computer, a smart television, a smart watch or wearable device, smart glasses, a stereoscopic display, a wearable camera, extended reality (XR) glasses, XR goggles, a near-eye display device, or any other suitable type of user equipment or computing device, or any combination thereof.

In some embodiments, electronic game 101 may be an XR experience. XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) the user in a three-dimensional, computer-generated environment. Such environments may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world, or the real world is otherwise connected to virtual objects.

A user may desire to participate in a computing session for an electronic game constrained by a time duration or range, based on, for example, a user's busy schedule or limited amount of free time to participate in leisure activities. Additionally, to obtain the most benefit/enjoyment out of the computing session for the electronic game, it is desirable to participate in the computing session at a consistent difficulty that adequately challenges the user. By employing a deep learning model that maintains a computing session at a consistent difficulty that allows a user to advance the computing session to a particular outcome within the desired time period, a gaming system may conserve critical resources that would otherwise be spent to fuel a dynamically updating learning model, as shown below.

In the example of FIG. 1A, game system 100 receives a user-interface input to begin a computing session for electronic game 101 (e.g., an electronic board game) from a user (e.g., user 102). In some embodiments, game system 100 receives the user-interface input when user 102 interacts with the user-interface of computing device 103. While the example of FIG. 1A depicts a single user (e.g., user 102), it should be appreciated that game system 100 and electronic game 101 may support any number of human users participating in the computing session for the electronic game simultaneously.

In some embodiments, when receiving the user-interface input to begin the computing session for electronic game 101, game system 100 prompts user 102 to make a user-interface input indicating the desired difficulty at which electronic game 101 should be provided via the game system. In some embodiments, game system 100 automatically determines the appropriate difficulty for presenting electronic game 101 within a target time period by analyzing a user's previous game-playing history, or by using crowd-sourced statistics gathered from a plurality of different users.

In some embodiments, game system 100 prompts user 102 to make a user-interface input that specifies the time window for completing the computing session for electronic game 101. In some embodiments, game system 100 provides user-selectable message 104, which enables user 102 to make a user-interface selection of a particular time window for to advance the computing session to a particular outcome. In some embodiments, user-selectable message 104 allows input of a particular outcome. In some embodiments, user-selectable message 104 is programmatically or automatically determined by the gaming system. In some embodiments, user-selectable message 104 is generated based on computing session preference information stored in a profile associated with the user. In some embodiments, the particular time window is provided as a maximum time duration for the computing session (e.g., no more than 25 minutes). In some embodiments, the particular time window is provided as a desired range of time for the computing session (e.g., between 20 and 25 minutes). For example, as shown in FIG. 1A, user-selectable message 104 provides two different user-selectable options for specifying a desired time duration of the computing session (e.g., a first user-selectable option indicating a desired time range of 20 to 25 minutes and a second user-selectable option indicating a desired maximum time duration of “no more than 25 mins”). Game system 100 is configured to receive a user selection of one of the user-selectable options in user-selectable message 104 from user 102.

In some embodiments, game system 100 automatically determines an appropriate time window for completing a computing session for an electronic game by accessing a user's calendar, historical data related to previous computing sessions of the user, activity plans of the user, short messages, or any other suitable indication of a user's available time. In some embodiments, in response to receiving a user's selection of a desired game difficulty for the computing session of an electronic game, game system 100 automatically determines the appropriate time window that corresponds to the desired game difficulty, such that the computing session remains engaging and entertaining for the entire window of time. For example, if a user requests to participate in a computing session for an electronic game at an “easy” difficulty, game system 100 may configure the computing session to conclude in 10 minutes. However, if game system 100 configures the computing session to conclude in 25 minutes at an “easy” difficulty, the user may still win the game at the 10-minute time, which may not be an efficient use of the user's available time. In some embodiments, the opposite effect may occur if the difficulty is set to “hard” or any other higher level of difficulty.

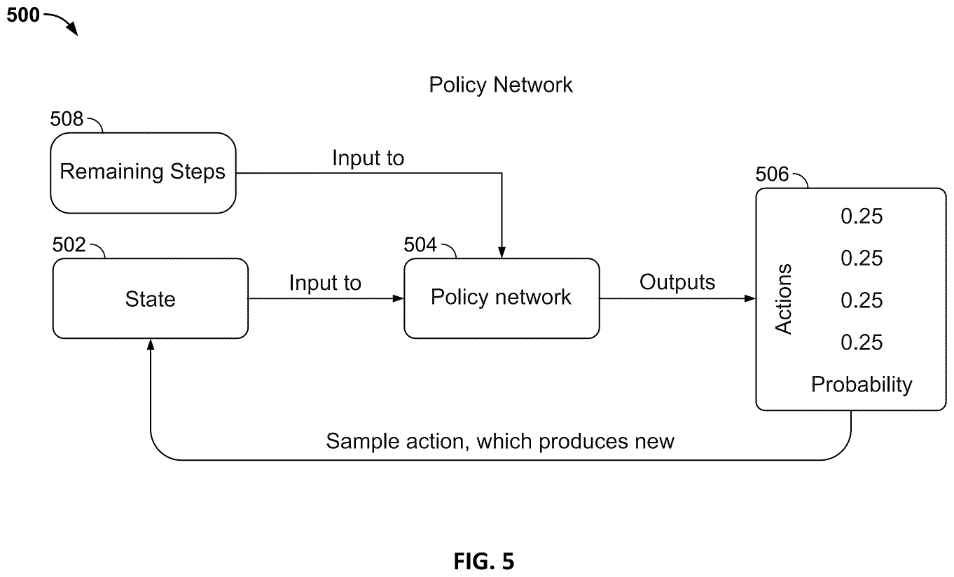

In some embodiments, the selected or determined time window is input into deep learning model 112, which is trained to conform a computing session for an electronic game into a specified time window. In some embodiments, deep learning model 112 comprises a plurality of neural networks, such as time-aware policy network 114 and time-aware value network 118. In some embodiments, time-aware policy network 114 of deep learning model 112 is applied to a particular computing session by analyzing the current game state of game board 110, a number of remaining steps (e.g., indicated by move counter 108), and the specific time window. More detailed information related to the time-aware policy network is described in relation to FIG. 5 below.

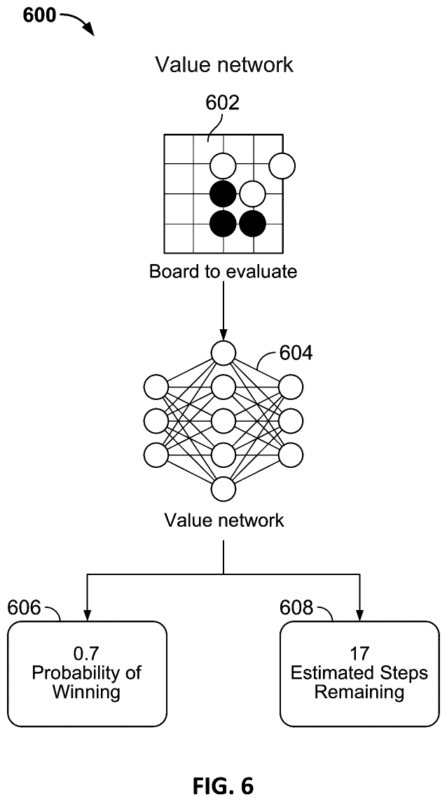

In some embodiments, time-aware value network 118 of deep learning model 112 is trained by analyzing previous computing sessions for electronic game 101. For example, time-aware value network 118 is trained by accessing each previous computing session for electronic game 101 and determining a plurality of previous game states for each previous computing session, determining which computing sessions for the electronic game resulted in a win result, determining which computing sessions for the electronic game resulted in a loss result and determining an average number of remaining steps to complete each previous computing session from each previous game state, respectively. Additional information related to the time-aware value network is described in relation to FIG. 6 below. In some embodiments, depending on the type of electronic game being played, one “step,” “move,” or “action” to be performed in the electronic game is associated with an amount of time.

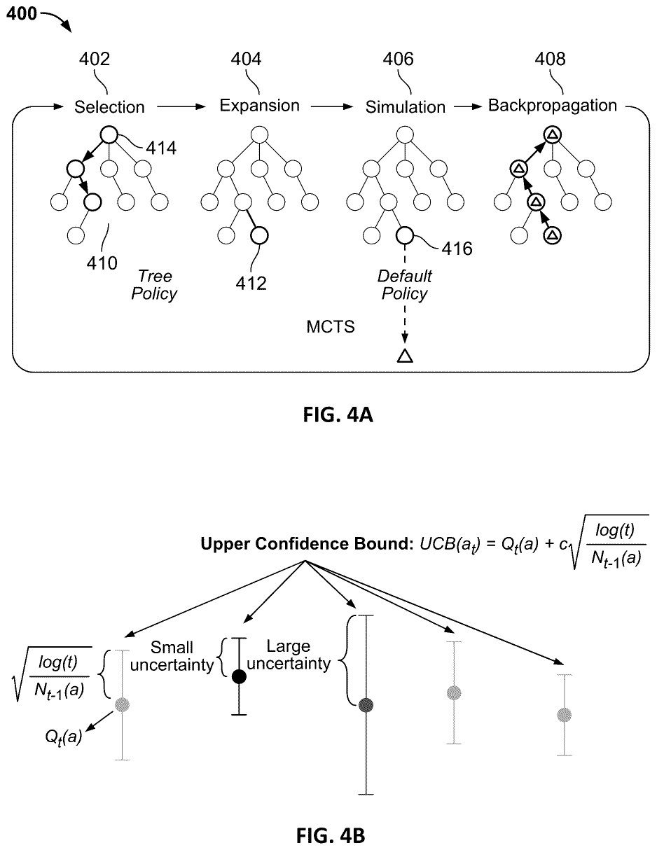

In some embodiments, deep learning model 112 is configured to consider a time-aware upper confidence bound (UCB) value, based on the selected or determined time window and a reward value for searching each node in a data structure using a search algorithm. In some embodiments, the search algorithm is a heuristic search algorithm, such as a Monte Carlo Tree Search (MCTS). In some embodiments, time-aware UCB 116 is input into deep learning model 112 in order to guide the selection phase of MCTS 120, which searches a data structure for the best possible node corresponding to an in-game move or action to advance the computing session to a particular outcome within the specified time window. In some embodiments, a node of a data structure represents an in-game move or action to be made within the computing session. In some embodiments, time-aware UCB 116 influences the selection phase of MCTS 120 by balancing exploration (e.g., trying out less-visited nodes to discover their potential) and exploitation (e.g., selecting nodes that have yielded high rewards in the past). Additional information related to the MCTS is provided in relation to FIG. 4A below. Additional information related to the time-aware UCB is provided in relation to FIG. 4B below.

In some embodiments, deep learning model 112 is trained to utilize the outputs of time-aware policy network 114 and time-aware value network 118 to predict which in-game actions will have the highest probability of advancing the computing session to a particular outcome within the desired time. In some embodiments, deep learning model 112 is also trained to consider the time-aware UCB value when performing a MCTS to determine the best in-game action for completing the computing session within the specified time window. In some embodiments, at 121, once deep learning model 112 is properly trained using current game data and previous game data, deep learning model 112 is configured to output instructions for performing some in-game action in electronic game 101, in order to advance the electronic game towards completion of the computing session within the desired time window. In some embodiments, the in-game action output by deep learning model 112 is a recommendation for receiving a user-interface input indicating an interaction with a portion of content of the electronic game that is determined to be suitable for completing within the time window. In some embodiments, the in-game action output by deep learning model 112 is providing a human player (e.g., user 102) with dynamic hints to advance the computing session towards completion. In some embodiments, the in-game action output by deep learning model 112 is providing suggested in-game moves for a computer-based opponent to perform so as to advance the computing session towards completion within the time window. For example, as shown in FIG. 1A, deep learning model 112 outputs action 122, providing a suggestion for the computer-based opponent to make in-game move 124, which is determined to advance the computing session towards completion within 25 minutes, as indicated by clock 106. For example, if the electronic game is a player-vs-player (PVP) RPG game, the in-game action output by deep learning model 112 may be a suggestion to utilize certain power-ups, special abilities, in-game items or other in-game features designed to strengthen the user-player or to hamper an enemy opponent. In some embodiments, deep learning model 112 is configured to provide this output in response to considering the number of remaining moves (e.g., indicated by move counter 108), the amount of remaining time in the computing session (e.g., indicated by clock 106) and the results of any previous computing sessions related to electronic game 101, among other suitable parameters.

FIG. 1B depicts an example system for, e.g., sharing resources of an electronic game using a computer-based opponent, in accordance with some embodiments of the disclosure. In some embodiments, electronic games (e.g., hosted in a cloud server and/or hosting an AI-based or computer-based opponent in a network-connected server) may have limited capacity of computing resources that will limit how many players can access the electronic game and/or use the AI-based opponent at one time. For example, the electronic game may be electronic game 101 as described in relation to FIG. 1A.

In order to better optimize the resources of the game server and the AI engines (e.g., which provide the AI-based opponent), it is desirable to utilize a session scheduling engine configured to schedule various computing sessions. For example, each player equipment corresponding to each of the different players (e.g., player 1 equipment 134, player 2 equipment 136, and player 3 equipment 138) may be accessing game servers 130 via network 132. While the example provided by FIG. 1B is simplified and depicts only three different players' equipment, it should be appreciated that modern electronic games are capable of supporting hundreds or even thousands (or more) of players at any given time. In some embodiments, the different player equipment is user equipment 807, 808, and 810 of FIG. 8. In some embodiments, game servers 130 represent server 804 of FIG. 8. In some embodiments, network 132 represents communication network 809 of FIG. 8.

In some embodiments, when using AI-based opponent engine 128, computing resources are limited, and session scheduling engine 126 is used to ensure that each gaming session against the AI-based opponent fits into a desired computing session time window (e.g., as desired by each individual player based on their personal needs at that time). For instance, AI-based opponent engine 128, with session scheduling engine 126, may assign an AI-based opponent for each player accessing the electronic game and/or allocate a portion of an AI-based opponent model to participate in a game session. By using computing sessions restrained by time windows, game servers 130 may efficiently manage, allocate, and/or distribute computing resources. AI-based opponents may be scheduled and/or conformed to, e.g., to advance the computing session to a particular outcome within a time window (while, e.g., maintaining consistency of the opponent in the game session) using, e.g., AI-based opponent engine 128 and/or session scheduling engine 126. In some embodiments, AI-based opponent engine 128 and/or session scheduling engine 126 are accessed via game servers 130 over network 132. In some embodiments, AI-based opponent engine 128 and session scheduling engine 126 are stored locally and are accessed via a local network or within a local machine. In some embodiments, session scheduling engine 126 may communicate with player equipment to, e.g., determine schedules based on profiles, calendars, messages, emails, etc., stored locally and/or in network-connected storage.

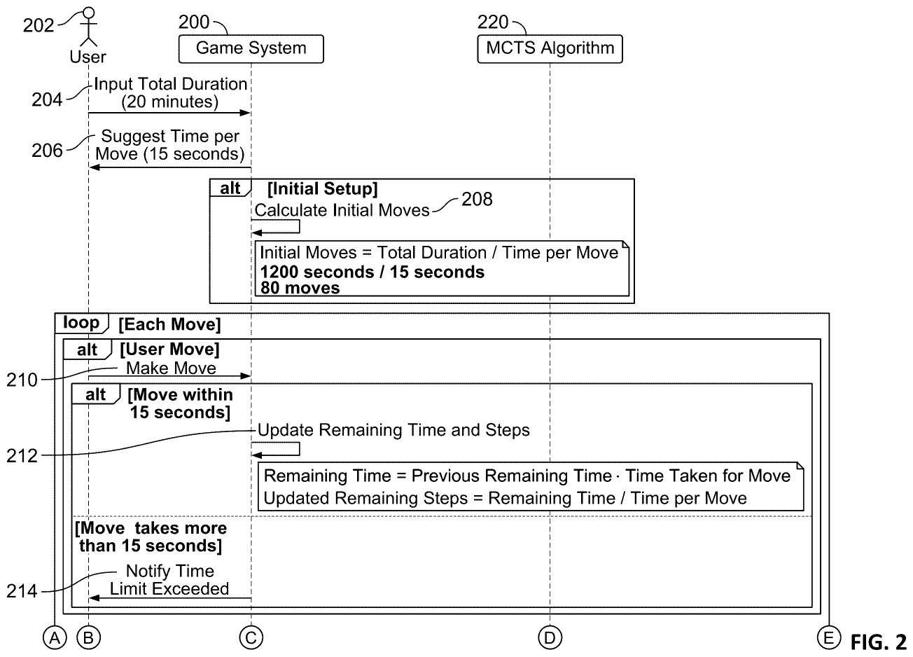

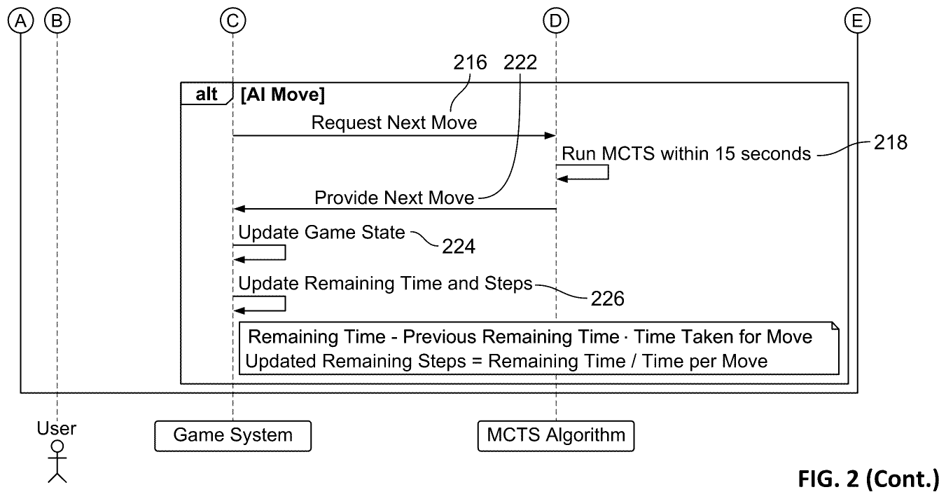

FIG. 2 is a flow diagram of an example process for conforming a computing session for an electronic game into a time window using a deep learning model, in accordance with some embodiments of the disclosure. At step 204, game system 200 (e.g., game system 100 of FIG. 1A) receives a user-interface input from user 202 (e.g., user 102 of FIG. 1A) specifying the desired duration of a computing session for an electronic game (e.g., 20 minutes). In some embodiments, at step 204, game system 200 also receives a user-interface input from user 202 indicating a desired outcome of the computing session (e.g., completing the computing session within the specified duration of time). In some embodiments, the electronic game is electronic game 101 of FIG. 1A. In some embodiments, game system 200 receives the user-interface input from user 202 in any manner as previously described in relation to FIG. 1A. In some embodiments, at step 206, game system 200 determines a suggested time per move, in order to advance the computing session to a particular outcome within the time window (e.g., 20 minutes). In some embodiments, a user-interface notification indicates the suggested time per move. In some embodiments, if the electronic game is a turn-based strategy game or a board game, game system 200 determines a suggested time per move based on the average number of moves typically needed to complete a game of this type. In some embodiments, game system 200 obtains the information required for determining the estimated number of actions and the suggested time per action by utilizing the output from a time-aware value network (e.g., time-aware value network 118 of FIG. 1A). In some embodiments, where the total time is shorter than average and the time limit for each move is shorter, game system 200 will suggest a more reasonable time limit for each move. Therefore, the target number of moves will be smaller than the average number of moves, and game system 200 will try to finish the game within the target number of moves. Because the computing session is dynamic, the target number of moves will change, and game system 200 will dynamically adapt to those changes in order to complete the computing session within the desired time window.

In some embodiments, at step 208, game system 200 determines the initial set up of the game space by calculating the number of initial moves. In some embodiments, game system 200 performs this calculation by dividing the total time duration (e.g., 1,200 seconds) by the suggested time per move (e.g., 15 seconds per move).

In some embodiments, once the computing session has begun at step 210, game system 200 responds to receiving a user-interface input of a first move made by user 202. At step 212, after user 202 has made their first move, game system 200 updates the remaining time and number of moves based on how long it took user 202 to make their first move. For example, if user 202 made their move within the suggested time limit per move (e.g., 15 seconds), game system 200 updates the remaining time by subtracting the time taken for a move from the previous remaining time value. Continuing from the above example, game system 200 also updates the number of remaining steps by dividing the remaining time value by the time per move. In some embodiments, user 202 takes more than the suggested time limit per move (e.g., 15 seconds) to make a move. If user 202 takes too long to make a move, at step 214, game system 200 will generate for display on a user interface (e.g., the user interface of computing device 103 of FIG. 1A) a notification indicating the time window for advancing the computing session to a particular outcome (e.g., indicating that user 202 has taken too long to make an in-game move). In some embodiments, at step 214, game system 200 will provide a dynamic hint to user 202 and the dynamic hint will suggest a particular in-game move for overcoming the opponent.

In some embodiments, at step 216, game system 200 requests the next move of an AI-based opponent. For example, game system 200 requests such information from the MCTS algorithm. At step 218, the MCTS algorithm receives the request from game system 200 and begins to run the algorithm to determine a move for an AI-based opponent to make that will help advance the computing session towards completion within the target time window (e.g., 20 minutes). For example, by utilizing the current state of the game and the updated remaining number of steps to guide the searching and decision making, the MCTS is able to indicate the next move for an AI-based opponent to make that will advance the computing session towards completion within the target time window. In some embodiments, the MCTS algorithm is MCTS 120 of FIG. 1A.

In some embodiments, the MCTS algorithm utilizes the time-aware UCB formula (e.g., time-aware UCB 116 of FIG. 1A), which is calculated based on the updated remaining steps, to prioritize certain nodes of a data structure that can lead to a conclusion of the computing session within the time limit. In some embodiments, the MCTS simulates possible game outcomes from the selected nodes from the data structure. In some embodiments, the MCTS focuses on nodes (e.g., in-game moves) that are reasonably expected to maintain the computing session within the expected remaining duration. In some embodiments, once a node is selected, the MCTS updates all the nodes (e.g., all nodes from the selected node back to the root of the data structure) based on both the in-game outcome and how well the selected node adhered to the time constraint. Additional information related to the MCTS and UCB calculations are described in greater detail in relation to FIGS. 4A-4B below.

In some embodiments, at step 218, the MCTS algorithm is run within the suggested time per move (e.g., 15 seconds). Subsequent to running the MCTS algorithm, at step 222, the MCTS algorithm provides the determined next move to game system 200. For example, the MCTS algorithm will identify the best move to be made by the AI-based opponent, and game system 200 will receive that identification. Next, game system 200 will generate for display a move by the AI-based opponent corresponding to the selected node identified by the MCTS algorithm. In some embodiments, at step 224, game system 200 updates the current state of the game by including the most recent move made by the AI-based opponent. In some embodiments, at step 226, after the AI-based opponent has made its move, game system 200 updates the remaining time and number of moves in a similar manner as previously described in relation to step 212 of this figure.

It should be appreciated that steps 210, 212, 214, 216, 218, 222, 224 and 226 are performed in response to each move made by either the human player (e.g., user 202) or the AI-based opponent. In some embodiments, the above example process is performed in response to output from a deep learning model (e.g., deep learning model 112, as further described in relation to FIG. 1A). Thus, game system 200 may dynamically update the remaining time and game state of the computing session, such that each subsequent move by either the human player or the AI-based opponent advances the computing session towards a particular outcome within the target time duration or range.

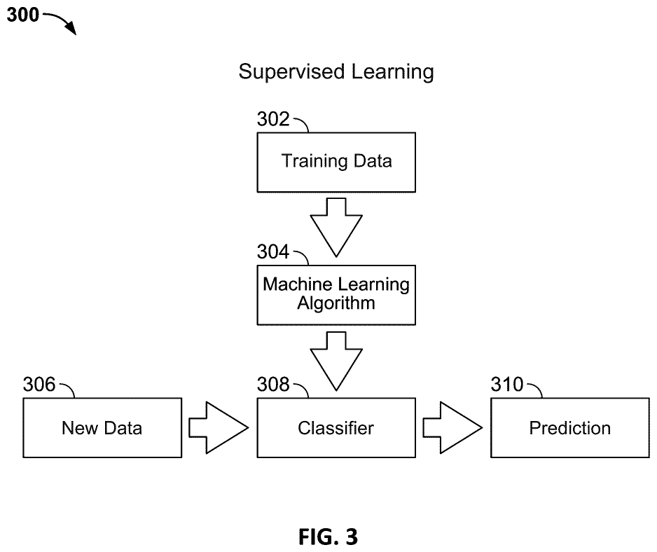

FIG. 3 depicts an example diagram of training a learning model using supervised learning, in accordance with some embodiments of the disclosure. In some embodiments, a deep learning model (e.g., deep learning model 112, as further described in relation to FIG. 1A) is trained using a process called “supervised learning.” Supervised learning is a category of machine learning that utilizes labeled data sets (e.g., input data that is paired with a desired output) to train a learning model. The learning model learns to accurately predict an output in response to receiving new data, which may be useful for tasks such as object detection, regression and classification.

In some embodiments, process 300 begins when a machine learning algorithm (e.g., machine learning algorithm 304) is trained using training data 302. In some embodiments, training data 302 consists of input/output pairs, and each piece of data in the training data is associated with a label or value. In some embodiments, training data 302 features input data in the form of numerical values, images, or text, and the output data may be a category label or a value. For example, in a task to classify emails as “spam” or “not spam,” the training data would consist of emails (input) and corresponding labels (spam/not spam).

In some embodiments, the machine learning algorithm is a deep learning model (e.g., deep learning model 112, as further described in relation to FIG. 1A), which comprises various neural networks, such as a time-aware policy network and a time-aware value network (e.g., time-aware policy network 114 and time-aware value network 118 further described in relation to FIG. 1A). In some embodiments, training data 302 is an analysis of many previous computing sessions involving electronic games and a determination of previous game states, labeled with both the game outcome (e.g., win/loss), and the average number of steps remaining from that previous game state to the end of the game, which is used to train the time-aware value network of machine learning algorithm 304. In some embodiments, training data 302 is labeled with “time-to-end” as an additional feature. In some embodiments, training data 302 is a large data set of expert gaming sessions, which trains the time-aware policy network to learn and predict the in-game moves a human expert would make.

In some embodiments, machine learning algorithm 304 receives training data 302 and begins to map the training data to its corresponding output labels, in a variety of ways. For example, a machine learning algorithm may map certain data in the form of decision trees, support vector machines (SVM), neural networks or any other suitable data structure. For example, as described in more detail in relation to FIGS. 4A-4B below, a deep learning model may organize data in the form of a data structure that may be efficiently searched using a MCTS. Machine learning algorithm 304 processes training data 302 by applying mathematical functions and adjusting weights (e.g., as further described in relation to FIGS. 4A, 4B, 5 and 6 below) with the goal of minimizing any discrepancy between predicted outputs and the actual outputs in the training data (e.g., usually measured by a loss function).

At 306, new data is received by machine learning algorithm 304, which is now trained. For example, if a user is participating in a computing session for an electronic game (e.g., electronic game 101 of FIG. 1A or the electronic game described in relation to FIG. 2), the new data received by a learning model may be the current state of the game, an estimated number of remaining steps to conclude the computing session within a desired time window and a probability distribution indicating an outcome of a particular move. In some embodiments, the new data is different depending on the type of electronic game featured in the computing session. In some embodiments, new data is received during many instances of a computing session and the algorithm updates its results accordingly.

In some embodiments, a trained learning model is referred to as a classifier (e.g., classifier 308) based on the way that it has previously characterized, organized, and/or labeled the training data (training data 302). Classifier 308 receives the new data and analyzes the new data by associating it with various patterns learned from training data 302. Classifier applies the patterns learned from training data 302 and associates the new data with labels, scores, values, or any other suitable indication of how close the new data matches with the training data. Using the previous email example, the classifier would take a new email and determine whether it is spam or not based on the patterns it learned from the training data. In some embodiments, classifier 308 improves its accuracy as it is exposed to more diverse and representative training data.

In some embodiments, subsequent to receiving the new data, the deep learning model outputs prediction 310. For example, classifier 308 may apply a MCTS to search a data structure based on the newly received data, which will identify a portion of the data structure that indicates an action with the highest probability of accomplishing the task (i.e., a prediction). In some embodiments, the trained model receives the current state of the game, an estimated number of remaining steps to conclude game in time and a probability distribution as new data, and an MCTS is implemented to determine the in-game action for advancing the computing session to a particular outcome within the desired time window. In some embodiments, the in-game action is any of the in-game actions previously described in relation to FIG. 1A. In some embodiments, each prediction is associated with an error analysis and a loss function describing a possible discrepancy between a predicted outcome and an actual outcome. These values are adjusted based on the result of each prediction so that the learning model may improve its performance over time.

FIG. 4A depicts an illustrative system for using a search algorithm, such as a heuristic search technique or algorithm (e.g., Monte Carlo Tree Search (MCTS)), in a learning model to search through nodes of a data structure, in accordance with some embodiments of the disclosure. In some embodiments, various data is received by a learning model (e.g., deep learning model 112 of FIG. 1A), and organized into a data structure. In some embodiments, the data structure takes the form of a tree, such as data structure 410. In some embodiments, MCTS process 400 may be applied to data structure 410 to efficiently search the data structure by relying upon random sampling and statistical evaluation. In some embodiments, data structure 410 includes multiple nodes and edges, where each node in the data structure represents an in-game move determined to advance the computing session towards the particular outcome and each edge in the data structure represents various game states, respectively. In some embodiments, the edges between the nodes of the data structure represents a transition between a first game state and a second game state of a computing session.

In some embodiments, MCTS process 400 is a search algorithm that simulates many possible sequences of decisions to determine the decision with the highest probability of achieving the task. In some embodiments, MCTS process 400 comprises four primary steps: selection 402, expansion 404, simulation 406 and backpropagation 408. In some embodiments, selection 402 includes: starting from root 414 of data structure 410, successively searching child nodes (e.g., node 412) until a leaf node is reached. In some embodiments, a leaf node is a node in a data structure that has unexplored child node(s). For example, using a time-aware UCB formula to guide the MCTS, the MCTS can prioritize certain nodes in data structure 410 that can lead to a conclusion of a computing session within the time limit. In some embodiments, expansion 404 includes: if the leaf node is not in a terminal state, expanding data structure 414 by adding one or more new child nodes from the leaf node. In some embodiments, a leaf node is in a terminal state when it has reached a predefined intensity (e.g., when a particular node concludes the computing session or otherwise results in a particular outcome). In some embodiments, simulation 406 includes simulating the electronic game from the new node until a node in a terminal state is reached. For example, based on the time constraints applied to a computing session, the MCTS may simulate game outcomes within those time constraints in order to identify which nodes correspond to in-game actions that will keep the electronic game within the expected remaining duration. In some embodiments, once a node in a terminal state is identified (e.g., node 416), backpropagation 408 includes updating the values associated with nodes along the path from node 416 to root 414 of data structure 410, based on the results of the simulation. For example, the MCTS will update the values associated with nodes based on the in-game outcome and how well the corresponding action adhered to the time constraints. In some embodiments (e.g., the example embodiment provided in FIG. 2 or an example when the electronic game is an electronic board game), each node in data structure 410 represents an in-game move that can be made. In some embodiments, using the above process, the MCTS evaluates each node to determine which node will result in an in-game move that will advance the computing session towards a particular outcome within the designated time window.

In some embodiments, the values associated with each node are provided by the UCB calculation, which is further described in relation to FIG. 4B. In some embodiments, the UCB formula influences selection 402 of the MCTS by balancing exploration (e.g., trying out less-visited nodes to discover their potential) and exploitation (e.g., choosing nodes that have yielded high rewards in the past). In some embodiments, the MCTS is configured to consider the output from the time-aware neural networks, such as the time-aware policy network and the time-aware value network. In some embodiments, a time-aware policy network (e.g., time-aware policy network 114 of FIG. 1A) guides the selection and expansion phases of the MCTS by suggesting promising nodes. In some embodiments, a time-aware value network (e.g., time-aware value network 118 of FIG. 1A) evaluates non-terminal leaf nodes to estimate their value without having to simulate an entire game to its end.

In some embodiments, the MCTS process 400 performs differently depending on the type of electronic game that it is applied to. For example, if the electronic game is a real-time strategy games (RTS) (e.g., StarCraft or Age of Empires), the MCTS may evaluate sequences of actions in a large state space to determine which sequences of actions will lead the computing session towards completion. As a further example, if the electronic game is a tactical role-playing game (RPGs) (e.g., Final Fantasy Tactics or Baldur's Gate), the MCTS can utilize a policy network to predict the best actions and a value network to evaluate different game states. The MCTS can then simulate different potential strategies within various time constraints. As yet a further example, if the electronic game is a puzzle game, a policy network can be trained to suggest the next move or placement, a value network can evaluate the likelihood of solving the puzzle from a given puzzle state, and the MCTS can explore different sequences of in-game moves to find the optimal solution.

FIG. 4B depicts an example diagram of how an upper confidence bound (UCB) is applied to the MCTS, in accordance with some embodiments of the disclosure. As previously mentioned, the UCB formula is a key component in the selection phase of the MCTS process as it balances exploration and exploitation when selecting nodes from a data structure. In some embodiments, the UCB formula may be represented by the following equation:

$$U C {B}_{i} = {Q}_{i} + C \sqrt{\frac{ln N}{{n}_{i}}} + {T}_{i}$$

In some embodiments, Qᵢ is the average reward of node i and C is the exploration parameter, which balances exploration and exploitation of nodes in a data structure. In some embodiments, a common value for C is \sqrt{2}. In some embodiments, N is the total number of simulations from a parent node, nᵢ is the number of times node i has been visited, and Tᵢ is the time constraint bias for node i. In some embodiments, Tᵢ can be a function that penalizes moves expected to extend the computing session beyond the target time duration.

In some embodiments, Qᵢ is the exploitation term that represents the average reward or win rate for a particular node i. For example, a higher value of Qᵢ indicates nodes that have performed well in previous computing sessions for electronic games. In some embodiments, the exploration term

$$C \sqrt{\frac{ln N}{{n}_{i}}}$$

encourages exploration of those nodes that have been visited less frequently during previous computing sessions. For example, as In N increases logarithmically with the total number of simulations, exploration is initially heavily promoted, but stabilizes over time. In some embodiments, having nᵢ in the denominator of the equation ensures that the exploration bonus decreases as a particular node is visited more often.

In some embodiments, the time constraint basis Tᵢ can be formulated to decrease as the remaining time diminishes and is represented by the following function:

$${T}_{i} = \frac{D}{{T}_{remaining}}$$

In some embodiments, D is a constant that determines the weight of the time penalty and T_{remaining} is the time remaining until the desired end of the computing session. In some embodiments, when T_{remaining} is large, Tᵢ becomes smaller, indicating that the level of urgency to conclude the computing session within the desired time window is low. In some embodiments, when T_{remaining} is small, Tᵢ becomes larger, indicating a higher level of urgency to conclude the computing session within the desired time window. This relationship ensures that the learning model instructs, for example, an AI-based opponent to adapt its strategy based on the remaining time, balancing the results of its in-game actions between optimal gameplay and the time constraint. By introducing a time constraint bias into the UCB formula, the modified algorithm encourages in-game moves that help conclude the game within the target time, addressing the requirement to end the game or game session within a specified duration (e.g., 15 minutes). This approach may ensure that the AI-based opponent can make strategic decisions while also adhering to time constraints, making the electronic game more accessible for players with limited time availability. In some embodiments, the appropriate difficulty level matching a time constraint, D₀, can be estimated from a user's gaming history or from crowd-sourced statistics from many other users, and may be applied to one or more of the formulas discussed.

In some embodiments, the goal of the computing session is not to conclude the electronic game within the target time window (e.g., from 0-15 minutes), but at the target duration with a tolerance window (e.g., a smaller target window such as 13-15 minutes). In this example, Tᵢ may be expressed by the following equation:

$${T}_{i} = \frac{{D}_{short}}{{T}_{remaining} - {T}_{min}} + \frac{{D}_{long}}{{T}_{max} - {T}_{remaining}}$$

In some embodiments, Dₛₕₒᵣₜ represents the penalty factor for finishing a computing session too early, D_{long} represents the penalty factor for finishing a computing session too late, Tₘᵢₙ represents the lower bound of the target window (e.g., 13 minutes), Tₘₐₓ represents the upper bound of the target window (e.g., 15 minutes) and T_{remaining} represents the time remaining until the target end time.

In some embodiments, when T_{remaining} is close to Tₘᵢₙ, if T_{remaining} is only slightly more than Tₘᵢₙ, then the term

$$\frac{{D}_{short}}{{T}_{remaining} - {T}_{min}}$$

becomes very large. For example, this high value significantly increases Tᵢ, making an AI-based opponent highly sensitive to the risk of finishing an electronic game too early. As a result, the level of urgency increases to avoid in-game moves that might lead to a game duration that is less than Tₘᵢₙ. In some embodiments, when T_{remaining} is close to Tₘₐₓ, if T_{remaining} is only slightly less than Tₘₐₓ, then the term

$$\frac{{D}_{long}}{{T}_{max} - {T}_{remaining}}$$

becomes very large. For example, this high value significantly increases Tᵢ, making an AI-based opponent highly sensitive to the risk of finishing an electronic game too late. As a result, the level of urgency increases to avoid in-game moves that might lead to a game duration that exceeds Tₘₐₓ. In some embodiments, when T_{remaining} is between Tₘᵢₙ and Tₘₐₓ and T_{remaining} is comfortably between Tₘᵢₙ and Tₘₐₓ, both

$$\frac{{D}_{short}}{{T}_{remaining} - {T}_{min}} and \frac{{D}_{long}}{{T}_{max} - {T}_{remaining}}$$

are moderate. For example, this moderate value results in a lower overall Tᵢ, which indicates less of an urgency to conclude the computing session. As a result, an AI-based opponent focuses more on strategic gameplay with a moderate sensitivity to time constraints.

In some embodiments, by incorporating penalties for finishing a computing session too early or too late, the modified UCB formula encourages in-game actions that help conclude the electronic game within a specified time window. This approach ensures that the AI-opponent, based on instructions received from a learning model, can make strategic decisions while adhering to a more precise timeframe, making the electronic game more suitable for players with specific time constraints.

FIG. 5 depicts an example diagram of a time-aware policy network in a learning model, in accordance with some embodiments of the disclosure. In some embodiments, a time-aware policy network (e.g., time-aware policy network 504) is configured to suggest possible nodes (i.e., in-game actions) for the MCTS to select in a data structure (e.g., data structure 410 of FIG. 4A). In some embodiments, the time-aware policy network is time-aware policy network 114 of FIG. 1A. As previously mentioned, the time-aware policy network works cooperatively with the time-aware value network in order to guide the MCTS towards the nodes associated with the highest possibility of advancing a computing session towards a particular outcome within a particular time window. Thus, time-aware policy network 504 is able to suggest particular in-game moves that are optimal in terms of game strategy, but also aim to conclude the computing session within the target time period.

In some embodiments, time-aware policy network 504 is trained using the supervised learning process described in relation to FIG. 3. For example, time-aware policy network 504 may be trained on a large data set of expert games, to learn to predict the in-game moves that expert-level human players would likely make in each of various situations. In some embodiments, the training of time-aware policy network 504 is further refined via reinforcement training. For example, time-aware policy network 504 can improve its analysis of data by playing numerous games against itself and using the outcomes of those games to update its parameters.

In some embodiments, to train time-aware policy network 504, a modified network architecture is established. For example, the training data is input to the network, and time-aware policy network 504 is trained using backpropagation and gradient descent in order to minimize any cross-entropy loss. In some embodiments, time-aware policy network 504 involves cross-entropy loss (e.g., loss function) between predicted in-game move probabilities and target in-game move probabilities to reduce the chance of a discrepancy between these values. For example, the loss represents any difference between the impact of a predicted move and the actual impact that the predicted move has on the computing session, once it is implemented into the computing session.

In some embodiments, time-aware policy network 504 is configured to accept or apply as inputs the current state of the game (e.g., game state 502), the estimated number of steps remaining to end the computing session (e.g., remaining steps 508), which corresponds to an amount of time, and a target probability distribution related to in-game moves (e.g., derived from the expert games or self-play data obtained during the training process). In some embodiments, the estimated number of steps remaining is the same as the number of steps that may be performed, based on the remaining time, to decide on and effectuate an in-game move. In some embodiments, time-aware policy network 504 estimates the number of steps in any way as previously described in relation to FIG. 2. For example, if the electronic game is a game of Checkers, the current state of the game may indicate the organization/arrangement of the pieces on the board at a particular time point in the game (e.g., a human player's fourth move). In some embodiments, time-aware policy network 504 is configured to output a probability distribution related to the nodes in a data structure, where the probability distribution indicates which nodes have the highest probability of advancing the electronic game towards a desired outcome. In some embodiments, the estimated number of remaining steps is concatenated with the features of the current game state before that information is fed into the neural network.

FIG. 6 depicts an example diagram of a time-aware value network in a learning model, in accordance with some embodiments of the disclosure. In some embodiments, a time-aware value network (e.g., time-aware value network 604) is configured to evaluate game states of electronic games (e.g., game state 602) and calculate a win probability (e.g., value 606), as well as determine an average number of remaining actions or steps (e.g., value 608) to complete a computing session or advance the computing session to an outcome based on the game state. In some embodiments, the time-aware value network is time-aware value network 118 of FIG. 1A. In some embodiments, in the context of the MCTS to search a data structure (e.g., data structure 410 of FIG. 4A), time-aware value network 604 evaluates the non-terminal leaf nodes of the data structure and outputs an estimation of their value (e.g., value 606 or 608) without having to simulate an entire playthrough of an electronic game to an end point. Without having to search all nodes of the data structure, critical computing resources are conserved, and increased efficiency is achieved.

In some embodiments, time-aware value network 604 is configured to output two scalar values based on any given game state (e.g., game state 602): the probability of winning (e.g., value 606) and an estimation of the average number of actions or steps remaining to end the electronic game (e.g., value 608). In some embodiments, value 606 and value 608 are the “reward” referred to in relation to FIGS. 1A and 4A-4B. In some embodiments, the average number of steps can be converted to an estimation of time to the ending of the game given the game's settings (e.g., difficulty), such that this information is used to evaluate potential nodes during the MCTS.

In some embodiments, time-aware value network 604 is trained by a simulating a plurality of self-played games to learn which board positions are most likely to result in a win. In some embodiments, time-aware value network 604 is trained using the reinforcement learning techniques described in relation to the time-aware policy network of FIG. 5. In some embodiments, time-aware value network 604 is trained by receiving data (e.g., input) in the form of various game states, where each game state (i.e., piece of data) is labeled by the eventual outcome in the game (e.g., win or loss). In some embodiments, the training data is also labeled by the average number of remaining steps to end the game from a particular game state. Thus, time-aware value network 604 is capable of predicting the probability of winning an electronic game from any given game state.

In some embodiments, the training data is augmented to record the number of in-game moves left at each particular game state in addition to the final outcome. For example, each game state sᵢ should be represented in the training data as a pair (yᵢ, tᵢ), where yᵢ is the binary label indicating a win or loss, and tᵢ is the average number of steps remaining from sᵢ to a given outcome of the game.

In some embodiments, to train the time-aware value network to predict both the win probability and the actions or steps remaining to reach a particular outcome, a loss function is utilized to account for both outputs. For example, a combined loss function that integrates binary cross-entropy (BCE) loss for the win probability and mean squared error (MSE) loss for the steps remaining is appropriate. The total loss (L) can be formulated as:

$$L = {L}_{win} + λ \cdot {L}_{steps}$$

where:

$${L}_{Win} = \frac{1}{N} {\sum }_{i = 1}^{N} [ {y}_{i} log ( {p}_{i} ) + ( 1 - {y}_{i} ) log ( 1 - {p}_{i} ) ] , and$$

$${L}_{steps} = \frac{1}{N} {\sum }_{i = 1}^{N} {( {t}_{i} - \begin{matrix}∧ \\ {t}_{i}\end{matrix} )}^{2} .$$

In some embodiments, N is the number of samples, yᵢ is the actual win/loss label for the i-th sample, pᵢ is the predicted probability of winning for the i-th sample, tᵢ is the actual number of steps remaining for the i-th sample and

$$\begin{matrix}∧ \\ {t}_{i}\end{matrix}$$

is the predicted number of steps remaining for the i-th sample. In some embodiments, the combined loss function is used to update the node weights in the data structure, which represent values 606 and 608. In some embodiments, the binary cross-entropy loss ensures that the time-aware value network accurately predicts the probability of winning, while the mean squared error loss ensures that the time-aware value network also learns to predict the number of in-game moves remaining.

FIG. 7 depicts illustrative devices and systems for conforming a computing session for an electronic game into a time window using a deep learn model, in accordance with some embodiments of the disclosure.

FIG. 7 shows generalized embodiments of illustrative user equipment 700 and 701. For example, user equipment 700 may be a smartphone device, a laptop, a tablet, a near-eye display device, an XR device, or any other suitable device. In another example, user equipment 701 may be a user television equipment system or device. User equipment 701 may include set-top box 716. Set-top box 716 may be communicatively connected to microphone 717, audio output equipment (e.g., speaker or headphones 714), and display 712. In some embodiments, microphone 717 may receive audio corresponding to a voice of a video conference participant and/or ambient audio data during a video conference. In some embodiments, display 712 may be a television display or a computer display. In some embodiments, set-top box 716 may be communicatively connected to user input interface 710. In some embodiments, user input interface 710 may be a remote-control device. In some embodiments, user input interface 710 also comprises I/O circuitry. Set-top box 716 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 8. In some embodiments, device 700 may comprise any suitable number of sensors (e.g., gyroscope or gyrometer, or accelerometer, etc.), and/or a GPS module (e.g., in communication with one or more servers and/or cell towers and/or satellites) to ascertain a location of device 700. In some embodiments, device 700 comprises a rechargeable battery that is configured to provide power to the components of the device.

Each one of user equipment 700 and user equipment 701 may receive content and data via input/output (I/O) path 702. I/O path 702 may provide content (e.g., broadcast programming, on-demand programming, internet content, content available over a local area network (LAN) or wide area network (WAN), and/or other content) and data to control circuitry 704, which may comprise processing circuitry and storage 708. Control circuitry 704 may be used to send and receive commands, requests, and other suitable data using I/O path 702, which may comprise I/O circuitry. I/O path 702 may connect control circuitry 704 (and specifically the processing circuitry) to one or more communications paths (described below). I/O functions may be provided by one or more of these communications paths, but are shown as a single path in FIG. 6 to avoid overcomplicating the drawing. While set-top box 716 is shown in FIG. 6 for illustration, any suitable computing device having processing circuitry, control circuitry, and storage may be used in accordance with the present disclosure. For example, set-top box 716 may be replaced by, or complemented by, a personal computer (e.g., a notebook, a laptop, a desktop), a smartphone (e.g., device 700), an XR device, a tablet, a network-based server hosting a user-accessible client device, a non-user-owned device, any other suitable device, or any combination thereof.

Control circuitry 704 may be based on any suitable control circuitry such as processing circuitry. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 704 executes instructions for the media application stored in memory (e.g., storage 708). Specifically, control circuitry 704 may be instructed by the media application to perform the functions discussed above and below. In some implementations, processing or actions performed by control circuitry 704 may be based on instructions received from the media application.

In client/server-based embodiments, control circuitry 704 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 7, the instructions may be stored in storage 608, and executed by control circuitry 704 of a device 700.

In some embodiments, the media application may be a client/server application where only the client application resides on device 700, and a server application resides on an external server (e.g., server 804 and/or media content source 802). For example, the media application may be implemented partially as a client application on control circuitry 704 of device 700 and partially on server 804 as a server application running on control circuitry 811. Server 804 may be a part of a local area network with one or more of devices 700, 701 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 804 and/or an edge computing device), referred to as “the cloud.” Device 700 may be a cloud client that relies on the cloud computing capabilities from server 804 to generate personalized engagement options in a VR environment. The client application may instruct control circuitry 704 to generate personalized engagement options in a VR environment.

Control circuitry 704 may include communications circuitry suitable for communicating with a server, edge computing systems and devices, a table or database server, or other networks or servers. The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of user equipment, or communication of user equipment in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as media application data described above. Nonvolatile memory may also be used (e.g., to launch a boot-up routine and other instructions). Cloud-based storage, described in relation to FIG. 7, may be used to supplement storage 708 or instead of storage 708.

Control circuitry 704 may receive instruction from a user by way of user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of each one of user equipment 700 and user equipment 701. For example, display 712 may be a touchscreen or touch-sensitive display. In such circumstances, user input interface 710 may be integrated with or combined with display 712. In some embodiments, user input interface 710 includes a remote-control device having one or more microphones, buttons, keypads, any other components configured to receive user input or combinations thereof. For example, user input interface 710 may include a handheld remote-control device having an alphanumeric keypad and option buttons. In a further example, user input interface 710 may include a handheld remote-control device having a microphone and control circuitry configured to receive and identify voice commands and transmit information to set-top box 716.

Audio output equipment 714 may be integrated with or combined with display 712. Display 712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 712. Audio output equipment 714 may be provided as integrated with other elements of each one of device 700 and device 701 or may be stand-alone units. An audio component of videos and other content displayed on display 712 may be played through speakers (or headphones) of audio output equipment 714. In some embodiments, audio may be distributed to a receiver (not shown), which processes and outputs the audio via speakers of audio output equipment 714. In some embodiments, for example, control circuitry 704 is configured to provide audio cues to a user, or other audio feedback to a user, using speakers of audio output equipment 714. There may be a separate microphone 717 or audio output equipment 714 may include a microphone configured to receive audio input such as voice commands or speech. For example, a user may speak letters or words that are received by the microphone and converted to text by control circuitry 704. In a further example, a user may voice commands that are received by a microphone and recognized by control circuitry 704. Camera 718 may be any suitable video camera integrated with the equipment or externally connected. Camera 718 may be a digital camera comprising a charge-coupled device (CCD) and/or a complementary metal-oxide semiconductor (CMOS) image sensor. Camera 618 may be an analog camera that converts to digital images via a video card.

The media application may be implemented using any suitable architecture. For example, it may be a stand-alone application wholly implemented on each one of user equipment 700 and user equipment 701. In such an approach, instructions of the application may be stored locally (e.g., in storage 708), and data for use by the application is downloaded on a periodic basis (e.g., from an out-of-band feed, from an internet resource, or using another suitable approach). Control circuitry 704 may retrieve instructions of the application from storage 708 and process the instructions to provide video conferencing functionality and generate any of the displays discussed herein. Based on the processed instructions, control circuitry 704 may determine what action to perform when input is received from user input interface 710. For example, movement of a cursor on a display up/down may be indicated by the processed instructions when user input interface 710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 704 may allow a user to provide user profile information or may automatically compile user profile information. For example, control circuitry 704 may access and monitor network data, video data, audio data, processing data, participation data from a conference participant profile. Control circuitry 704 may obtain all or part of other user profiles that are related to a particular user (e.g., via social media networks), and/or obtain information about the user from other sources that control circuitry 704 may access. As a result, a user can be provided with a unified experience across the user's different devices.

In some embodiments, the media application is a client/server-based application. Data for use by a thick or thin client implemented on each one of user equipment 700 and user equipment 701 may be retrieved on-demand by issuing requests to a server remote to each one of user equipment 700 and user equipment 701. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on device 700. This way, the processing of the instructions is performed remotely by the server while the resulting displays (e.g., that may include text, a keyboard, or other visuals) are provided locally on device 700. Device 700 may receive inputs from the user via input interface 710 and transmit those inputs to the remote server for processing and generating the corresponding displays. For example, device 700 may transmit a communication to the remote server indicating that an up/down button was selected via input interface 710. The remote server may process instructions in accordance with that input and generate a display of the application corresponding to the input (e.g., a display that moves a cursor up/down). The generated display is then transmitted to device 700 for presentation to the user.

In some embodiments, the media application may be downloaded and interpreted or otherwise run by an interpreter or virtual machine (run by control circuitry 704). In some embodiments, the media application may be encoded in the ETV Binary Interchange Format (EBIF), received by control circuitry 704 as part of a suitable feed, and interpreted by a user agent running on control circuitry 704. For example, the media application may be an EBIF application. In some embodiments, the media application may be defined by a series of JAVA-based files that are received and run by a local virtual machine or other suitable middleware executed by control circuitry 704. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

FIG. 8 depicts devices and systems including a server, a communication network, and a computing device, for performing the methods and processes noted herein, in accordance with some embodiments of the disclosure.

As shown in FIG. 8, user equipment 807, 808 and 810 may be coupled to communication network 809. Communication network 809 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 809) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths, but are shown as a single path in FIG. 8 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 809.

System 800 may comprise media content source 802, one or more servers 804, database 805, and/or one or more edge computing devices. In some embodiments, the media application may be executed at one or more of control circuitry 811 of server 804 (and/or control circuitry of user equipment 807, 808, 810 and/or control circuitry of one or more edge computing devices). In some embodiments, the media content source and/or server 804 may be configured to host or otherwise facilitate video communication sessions between user equipment 807, 808, 810 and/or any other suitable user equipment, and/or host or otherwise be in communication (e.g., over network 809) with one or more social network services.

In some embodiments, server 804 may include control circuitry 811 and storage 817 (e.g., RAM, ROM, Hard Disk, Removable Disk, etc.). Storage 717 may store one or more databases. Server 804 may also include an I/O path 812. I/O path 812 may provide video conferencing data, device information, or other data, over a local area network (LAN) or wide area network (WAN), and/or other content and data to control circuitry 811, which may include processing circuitry, and storage 817. Control circuitry 811 may be used to send and receive commands, requests, and other suitable data using I/O path 812, which may comprise I/O circuitry. I/O path 812 may connect control circuitry 811 (and specifically control circuitry) to one or more communications paths.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 811 executes instructions for an emulation system application stored in memory (e.g., the storage 817). Memory may be an electronic storage device provided as storage 817 that is part of control circuitry 811.

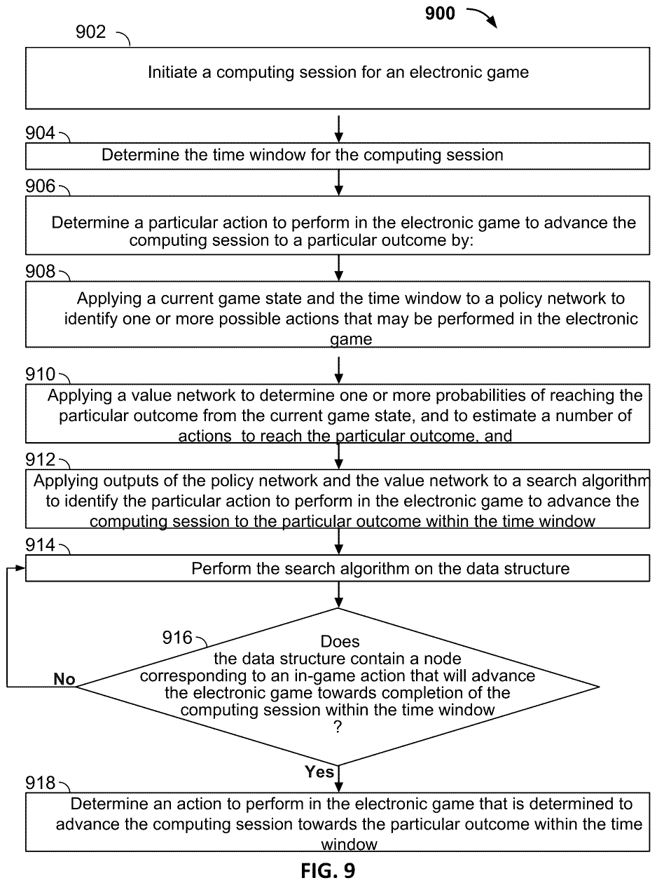

FIG. 9 is a flowchart of the process for performing an action to conform a computing session for an electronic game into a time window using a machine learning model, in accordance with some embodiments of the disclosure. In various embodiments, the individual steps of process 900 may be implemented by one or more components of the devices, techniques, and software of FIGS. 1-8. Although the present disclosure may describe certain steps of process 900 (and of other processes described herein) as being implemented by certain components of the devices and software of FIGS. 1-8, this is for purposes of illustration only, and it should be understood that other components of the devices and systems of FIGS. 1-8 may implement those steps instead.

Process 900 begins at step 902, where control circuitry (e.g., control circuitry 704 or 811 of FIGS. 7 and 8, respectively) of a user equipment receives a first user-interface input to begin a computing session for an electronic game. In some embodiments, at step 902, the control circuitry also receives a use-interface request indicating a desired outcome for a time-constrained computing session. In some embodiments, the electronic game is any electronic game as previously described in relation to FIGS. 1-6. At step 904, the control circuitry receives the time window for advancing the computing session for the electronic game. In some embodiments, the time window is received in any manner as previously described in relation to FIGS. 1A-1B (e.g., automatically or via a user-interface input selecting a time duration).

At step 906, the time window is input into a machine learning model that is trained to conform a computing session to a particular time window. In some embodiments, the learning model is deep learning model 112 of FIG. 1A, machine learning algorithm 304 or classifier 308 of FIG. 3, or any other suitable learning model. In some embodiments, the learning model comprises a time-aware policy network, which is trained to receive the current game state of the electronic game, an estimated number of remaining steps until the game reaches the desired outcome and the time window, as inputs. In some embodiments, the time-aware policy network helps to suggest nodes in a data structure for analysis by a search algorithm, e.g., the MCTS. In some embodiments, the time-aware policy network is time-aware policy network 114 of FIG. 1A, time-aware policy network 504 of FIG. 5, or any other suitable time-aware policy network. In some embodiments, the time window is input via a user interface. In some embodiments, the time window is determined via scheduling and/or calendar data from, e.g., a user profile, calendar, messages, emails, etc.

At step 908, the learning model comprises applying a time-aware value network, which is trained based on previous game states featured in previous computing sessions, of a plurality of previous computing sessions. In some embodiments, the plurality of previous computing sessions comprises at least one first result or outcome (e.g., a “win”) and at least one second result or outcome (e.g., a “loss). In some embodiments, the time-aware value network is capable of determining a probability of reaching a given outcome in an electronic game from any given game state, in the form of a reward value. In some embodiments, the time-aware value network determines an outcome probability in any manner as previously described in relation to FIGS. 1A-3 and 6.

At step 910, the time-aware value network is also trained to estimate an average number of remaining actions or steps to complete each previous computing session from the previous game state of each previous computing session. In some embodiments, the time-aware value network is time-aware value network 118 of FIG. 1A, time-aware value network 604 of FIG. 6, or any other suitable time-aware value network.

At step 912, the learning model determines and considers a UCB calculation or factor based on the designated time window and the reward value associated with each node (e.g., in game move) in a data structure. For example, a specific node with a high reward value may indicate that selection of the node will result in a high probability that the predicted outcome associated with the node will be implemented in the current computing session. In some embodiments, the UCB calculation is performed, and the value of that calculation is utilized in any manner as previously described in relation to FIGS. 1A-4B, for instance. In some embodiments, the UCB is used to guide the MCTS by balancing exploration and exploitation of unused or less-used nodes in the data structure.

At step 914, the learning model instructs the control circuitry to perform the MCTS on the data structure. In some embodiments, the MCTS is MCTS 120 of FIG. 1A, and the MCTS is performed in any manner as previously described in FIGS. 1A-6. At step 916, the learning model determines, via the MCTS constrained by the UCB, if the data structure contains a node that corresponds to an in-game action that will advance the electronic game towards a particular outcome of the computing session within the specified time window. If the data structure does not contain such a node, the process proceeds back to step 914, where the MCTS is run again in a new attempt to locate a more promising node. If, however, the data structure does contain a node that corresponds to a desired in-game action, process 900 continues to step 918, where the learning model determines an action to perform in the electronic game based on the output of the trained learning model. In some embodiments, the action is determined to advance the electronic game towards a particular outcome of the computing session within the time window.

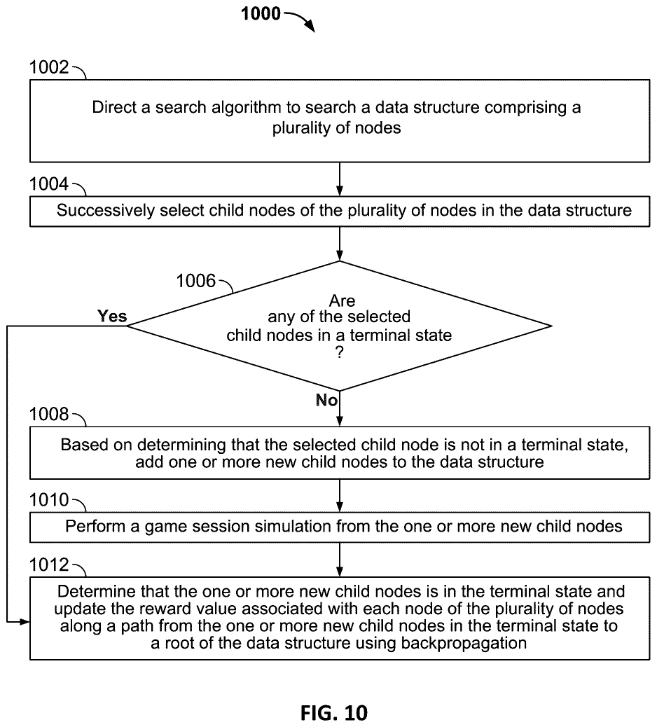

FIG. 10 is a flowchart of the process for performing search algorithm, such as a MCTS, in accordance with some embodiments of the disclosure. In various embodiments, the individual steps of process 1000 may be implemented by one or more components of the devices, techniques, and software of FIGS. 1-9. Although the present disclosure may describe certain steps of process 1000 (and of other processes described herein) as being implemented by certain components of the devices and software of FIGS. 1-9, this is for purposes of illustration only, and it should be understood that other components of the devices and systems of FIGS. 1-9 may implement those steps instead.

Process 1000 begins at step 1002, where control circuitry (e.g., control circuitry 704 or 811 of FIGS. 7 and 8, respectively) of a user equipment begins to perform a MCTS on a data structure, which may be any data structure as previously described. In some embodiments, the data structure comprises a plurality of nodes to be searched. In some embodiments, each node of the data structure is associated with an in-game action that can be performed to advance a computing session for an electronic game towards completion. In some embodiments, the MCTS is MCTS 120 of FIG. 1A, and the MCTS is performed in any manner as previously described in FIGS. 1A-6. In some embodiments, the MCTS is performed in response to instructions or output from a machine learning model, such as learning model 112 of FIG. 1A.

At step 1004, the MCTS begins to successively select child nodes from a plurality of child nodes in the data structure. For example, the search algorithm (e.g., MCTS) progresses through the possible in-game actions associated with each node, based on the current game state of the computing session. In some embodiments, the selection phase of the MCTS is guided by one or more of a time-aware policy network, a time-aware value network or a UCB calculation, such that the MCTS does not have to forcibly search each and every node in the data structure. At step 1006, the MCTS determines whether any of the selected child nodes are in a terminal state. If the MCTS has selected at least one child node that is in a terminal state (e.g., indicating an in-game move or series of in-game moves that will result in the desired outcome of the computing session), process 1000 skips to step 1012, where the MCTS determines that the node is in a terminal state and updates a reward value associated with each node along the path of the selected child node in the terminal state to the root of the data structure using backpropagation. If, however, the MCTS has not selected any child nodes in a terminal state, process 1000 process to step 1008, where the MCTS begins to add one or more new child nodes to the data structure in response to determining that none of the selected child nodes were in a terminal state.

At step 1010, the MCTS performs a game simulation from the one or more new child nodes to determine a prediction of how a particular node would perform if selected to be implemented in the electronic game. In some embodiments, the MCTS performs the simulation steps in any manner as previously described in relation to FIG. 4A. At step 1012, the MCTS determines that the one or more new child nodes is in the terminal state and begins to update the reward value associated with each node in the data structure along the path from the one or more new child nodes in the terminal state to the root of the data structure using backpropagation. In some embodiments, the selected node in the terminal state, which triggers the backpropagation, is ultimately selected for implementing into the electronic game.

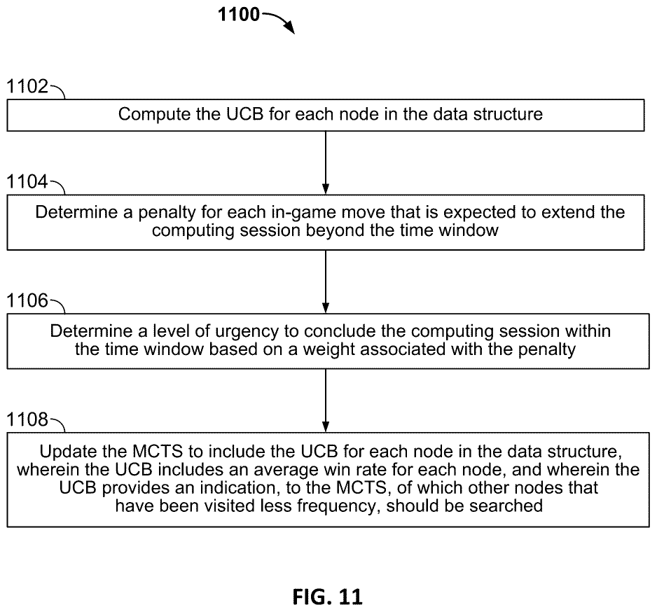

FIG. 11 is a flowchart of the process for calculating the UCB and applying the UCB to the MCTS, in accordance with some embodiments of the disclosure. In various embodiments, the individual steps of process 1100 may be implemented by one or more components of the devices and software of FIGS. 1-10. Although the present disclosure may describe certain steps of process 1100 (and of other processes described herein) as being implemented by certain components of the devices, techniques, and/or software of FIGS. 1-10, this is for purposes of illustration only, and it should be understood that other components of the devices, techniques, and/or systems of FIGS. 1-10 may implement those steps instead.

Process 1100 begins at step 1102, where control circuitry (e.g., control circuitry 704 or 811 of FIGS. 7 and 8, respectively) of a user equipment begins to compute the UCB for each node associated with the current game state, of a plurality of nodes in a data structure, which may be any data structure as previously described. In some embodiments, the UCB is any UCB calculation performed or utilized in relation to FIGS. 1A-6. At step 1104, a learning model determines, via the UCB calculation, a penalty for each node in the data structure that is expected to extend the computing session beyond the designated time window, where each node in the data structure is associated with an in-game move or action to be performed in a computing session for an electronic game. In some embodiments, the UCB calculation indicates the penalty in any manner as described in relation to FIG. 4B.

At step 1106, a learning model determines, via the UCB calculation, a level of urgency to conclude the computing session within the time window based at least in part on a weight associated with the penalty. In some embodiments, the UCB calculation indicates the level of urgency in any manner as described in relation to FIG. 4B. At step 1108, the learning model updates the MCTS to include the UCB calculation for each node in the data structure. In some embodiments, the UCB also includes an average win rate for each node in the data structure that is associated with the current game state. In some embodiments, the win rate is determined via output from a time-aware value network. In some embodiments, the UCB also provides an indication, to the MCTS, of the frequency in which certain nodes of the data structure have been searched. In some embodiments, based on the frequency in which certain nodes have been searched, the UCB indicates to the MCTS that it should search the nodes that have been visited less frequently.

While FIGS. 9-11 provide separate examples of various embodiments, it should be appreciated that one or more of the steps of these examples may be considered in combination.

Throughout the specification, the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for conforming a computing session of an electronic game to a time window, the method comprising:
initiating the computing session for the electronic game;
determining the time window for the computing session;
determining a particular action to perform in the electronic game to advance the computing session to a particular outcome within the time window, wherein the determining the particular action comprises:
applying a current game state and the time window to a policy network to identify one or more possible actions that may be performed in the electronic game;
applying a value network to determine one or more probabilities of reaching the particular outcome from the current game state, and to estimate a number of actions that may be performed from the current game state to reach the particular outcome; and
applying outputs of the policy network and the value network to a search algorithm to identify the particular action to perform in the electronic game to advance the computing session to the particular outcome within the time window, wherein the search algorithm is configured for analyzing one or more actions represented by nodes in a data structure, wherein edges between the nodes of the data structure represent transitions from a first game state to a second game state, and wherein the analyzing is constrained by an upper confidence bound (UCB) that includes a time constraint bias.

2. The method of claim 1, wherein the time window is one of a maximum time duration or a range of time.

3. The method of claim 1, further comprising:
automatically determining the time window by at least one of accessing a calendar associated with a user, or accessing historical data related to previous computing sessions.

4. The method of claim 1, further comprising:
concatenating the current game state and the estimated number of actions to advance the computing session to the particular outcome within the time window; and
providing the concatenated current game state and estimated number of remaining steps as an input to the policy network, wherein the policy network is trained using backpropagation and gradient descent, and wherein the policy network is configured to output a probability distribution of a plurality of in-game moves determined to advance the computing session to the particular outcome within the time window.

5. The method of claim 4, wherein the policy network comprises a first loss function that includes a binary cross-entropy loss between a plurality of predicted in-game move probabilities and a plurality of target in-game move probabilities, and wherein the policy network is trained based at least in part on a plurality of game states, the one or more possible actions that may be performed from a given game state to reach a given outcome, and the one or more probabilities associated with the one or more possible actions.

6. The method of claim 5, wherein the value network is configured to output a probability of achieving the particular outcome and the estimated number of actions to advance the computing session to the particular outcome within the time window based at least in part on the current game state, wherein the value network comprises a second loss function that includes a binary cross-entropy loss associated with the probability of reaching the particular outcome and a mean squared error loss associated with the estimated number of actions, wherein the value network is trained based at least on part on a plurality of games states, wherein each game state of the plurality of games states is associated one or more outcomes that may be performed from a respective game state to reach the given outcome, and wherein each action of the estimated number of actions is associated with an amount of time.

7. The method of claim 1, further comprising:
directing the search algorithm to search the data structure, wherein the data structure comprises a plurality of nodes, and wherein each node of the plurality of nodes is associated with an in-game action of a plurality of in-game actions;
successively selecting child nodes of the plurality of nodes;
based at least in part on determining that a selected child node is not in a terminal state, adding one or more new child nodes to the data structure;
performing a game session simulation from the one or more new child nodes;
determining that the one or more new child nodes is in the terminal state; and
updating a reward value associated with each node of the plurality of nodes along a path from the one or more new child nodes in the terminal state to a root of the data structure using backpropagation, wherein the reward value is determined by a reward function that includes penalties for exceeding the time window and rewards for finishing within the time window.

8. The method of claim 7, further comprising:
computing the UCB for each node of the plurality of nodes in the data structure by:
determining a penalty for each in-game action of the plurality of in-game actions that are expected to extend the computing session beyond the time window; and
determining a level of urgency to conclude the computing session within the time window based at least in part on a weight associated with the penalty; and
updating the search algorithm to include the UCB for each node of the plurality of nodes in the data structure, wherein the UCB includes an average win rate for each node of the plurality of nodes, wherein the UCB provides an indication, to the search algorithm, of which other nodes, of the plurality of nodes that have been visited less frequency, should be searched, and wherein a search depth of the search algorithm is dynamically adjusted based on the estimated number of actions.

9. The method of claim 1, further comprising:
determining a level of difficulty of the computing session for the electronic game corresponding to the time window, wherein the level of difficulty is determined based at least in part on historical data related to previous computing sessions or a plurality of crowd-sourced statistics; and
updating a deep learning model to include the level of difficulty, wherein the level of difficulty remains consistent throughout the computing session.

10. The method of claim 1, wherein the particular action to advance the computing session towards the particular outcome within the time window is at least one of: recommending interaction with a portion of content of the electronic game that is determined to be suitable for advancing the computing session towards the particular outcome within the time window, providing dynamic hints for a human player, or providing suggested moves for a computer-based opponent.

11. The method of claim 1, wherein the electronic game is an electronic turn-based strategy game, an electronic real-time strategy game, an electronic role-playing game, an electronic puzzle game, an electronic board game, or any other game that comprises a physical manifestation of computer-based actions.

12. The method of claim 1, further comprising:
generating for display a user interface, wherein the electronic game is presented on at least a portion of the user interface;
receiving a first user-interface input, via the user interface, to begin the computing session;
receiving, via the user interface, a notification indicating the time window for advancing the computing session;
receiving, via the user interface, a second user-interface input, via the user interface, indicating the particular outcome;
inputting the time window into a deep learning model trained to conform the computing session to the time window; and
performing the particular action to advance the electronic game towards the particular outcome of the computing session within the time window, wherein performing the particular action comprises at least one of:
generating for display, via the user interface, a recommendation for interacting with a portion of content of the electronic game that is determined to be suitable for advancing the computing session to the particular outcome within the time window;
generating for display, via the user interface, a dynamic hint for a human player; and
generating for display, via the user interface, an indication that suggested moves for a computer-based opponent have been provided.

13. A system comprising:
a memory; and
a control circuitry configured to:
initiate a computing session for an electronic game;
determine the time window for the computing session;
determine a particular action to perform in the electronic game to advance the computing session to a particular outcome within the time window, wherein the control circuitry is configured to determine the particular action by:
applying a current game state and the time window to a policy network to identify one or more possible actions that may be performed in the electronic game;
applying a value network to determine one or more probabilities of reaching the particular outcome from the current game state, and to estimate a number of actions that may be performed from the current game state to reach the particular outcome; and
applying outputs of the policy network and the value network to a search algorithm to identify the particular action to perform in the electronic game to advance the computing session to the particular outcome within the time window, wherein the search algorithm is configured for analyzing one or more actions represented by nodes in a data structure, wherein edges between the nodes of the data structure represent transitions from a first game state to a second game state, wherein the data structure is stored in the memory, and wherein the analyzing is constrained by an upper confidence bound (UCB) that includes a time constraint bias.

14-15. (canceled)

16. The system of claim 13, wherein the control circuitry is further configured to:
concatenate the current game state and the estimated number of actions to advance the computing session to the particular outcome within the time window; and
provide the concatenated current game state and estimated number of remaining steps as an input to the policy network, wherein the policy network is trained using backpropagation and gradient descent, and wherein the policy network is configured to output a probability distribution of a plurality of in-game moves determined to advance the computing session to the particular outcome within the time window.

17. The system of claim 16, wherein the policy network comprises a first loss function that includes a binary cross-entropy loss between a plurality of predicted in-game move probabilities and a plurality of target in-game move probabilities, and wherein the policy network is trained based at least in part on a plurality of game states, the one or more possible actions that may be performed from a given game state to reach a given outcome, and the one or more probabilities associated with the one or more possible actions.

18. The system of claim 17, wherein the value network is configured to output a probability of achieving the particular outcome and the estimated number of actions to advance the computing session to the particular outcome within the time window based at least in part on the current game state, wherein the value network comprises a second loss function that includes a binary cross-entropy loss associated with the probability of reaching the particular outcome and a mean squared error loss associated with the estimated number of actions, wherein the value network is trained based at least on part on a plurality of games states, wherein each game state of the plurality of games states is associated one or more outcomes that may be performed from a respective game state to reach the given outcome, and wherein each action of the estimated number of actions is associated with an amount of time.

19. The system of claim 13, wherein the control circuitry is further configured to:
direct the search algorithm to search the data structure, wherein the data structure comprises a plurality of nodes, and wherein each node of the plurality of nodes is associated with an in-game action of a plurality of in-game actions;
successively select child nodes of the plurality of nodes;
based at least in part on determining that a selected child node is not in a terminal state, add one or more new child nodes to the data structure;
perform a game session simulation from the one or more new child nodes;
determine that the one or more new child nodes is in the terminal state; and
update a reward value associated with each node of the plurality of nodes along a path from the one or more new child nodes in the terminal state to a root of the data structure using backpropagation, wherein the reward value is determined by a reward function that includes penalties for exceeding the time window and rewards for finishing within the time window.

20. The system of claim 19, wherein the control circuitry is further configured to:
compute the UCB for each node of the plurality of nodes in the data structure by:
determining a penalty for each in-game action of the plurality of in-game actions that are expected to extend the computing session beyond the time window; and
determining a level of urgency to conclude the computing session within the time window based at least in part on a weight associated with the penalty; and
update the search algorithm to include the UCB for each node of the plurality of nodes in the data structure, wherein the UCB includes an average win rate for each node of the plurality of nodes, wherein the UCB provides an indication, to the search algorithm, of which other nodes, of the plurality of nodes that have been visited less frequency, should be searched, and wherein a search depth of the search algorithm is dynamically adjusted based on the estimated number of actions.

21. The system of claim 13, wherein the control circuitry is further configured to:
determine a level of difficulty of the computing session for the electronic game corresponding to the time window, wherein the level of difficulty is determined based at least in part on historical data related to previous computing sessions or a plurality of crowd-sourced statistics; and
update a deep learning model to include the level of difficulty, wherein the level of difficulty remains consistent throughout the computing session.

22-23. (canceled)

24. The system of claim 13, wherein the control circuitry is further configured to:
generate for display a user interface, wherein the electronic game is presented on at least a portion of the user interface;
receive a first user-interface input, via the user interface, to begin the computing session;
receive, via the user interface, a notification indicating the time window for advancing the computing session;
receive, via the user interface, a second user-interface input, via the user interface, indicating the particular outcome;
input the time window into a deep learning model trained to conform the computing session to the time window; and
perform the particular action to advance the electronic game towards the particular outcome of the computing session within the time window, wherein the control circuitry is configured to perform the particular action by at least one of:
generating for display, via the user interface, a recommendation for interacting with a portion of content of the electronic game that is determined to be suitable for advancing the computing session to the particular outcome within the time window;
generating for display, via the user interface, a dynamic hint for a human player; and
generating for display, via the user interface, an indication that suggested moves for a computer-based opponent have been provided.

25-60. (canceled)
